(19) United States
(12) Patent Application Publication
(10) Pub. No.: US 2002/0110664 A1
(43) Pub. Date: Aug. 15, 2002

(54) Composite siding, decking, flooring, and planking boards and method of making same

(76) Inventor: Marc A. Seidner, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/112,845

(22) Filed: Mar. 28, 2002

Related U.S. Application Data
(63) Continuation of application No. 09/350,505, filed on Jul. 9, 1999, now abandoned.

(51) Int. Cl. B32B 7/00; B32B 3/10; D03D 15/00; D03D 25/00; B32B 23/02; B32B 1/00

(52) U.S. Cl. 428/131; 428/119; 428/192; 428/332; 442/181

(57) ABSTRACT

A composite siding and planking board having an appearance similar to a natural solid wood product and method of manufacture employing a base layer formed from an engineered wood product, a resin layer, a veneer layer and a filler strip wherein the resin layer is firmly bonded to the base layer and the resin layer is firmly bonded to the veneer layer such that the veneer layer, the resin layer and the base layer form a solid board that has a top edge and a bottom edge and where the filler strip is firmly attached near the bottom edge of the board so that the filler strip is configured to include a top edge receiving area such that the top edge of an identical composite board may be inserted into the top edge receiving area.

### CROSS-REFERENCE TO RELATED APPLICATION(S)

The present application is a continuation of co-pending patent application Ser. No. 09/350,505, filed Jul. 9, 1999, priority of which is hereby claimed under 35 U.S.C. §120.

### FIELD OF THE INVENTION

The present invention relates generally to the manufacture of building supplies and specifically to wood siding, and planking, decking and flooring boards.

### DISCUSSION OF THE RELATED ART

Within the building industry, one popular form of building and finishing material is wood siding which is used for covering both the exterior and interior of buildings. Historically, wood siding has added both durability and beauty to buildings.

One type of wood siding, known as “clapboard” siding, generally includes horizontally placed, interlocking boards which are generally triangular in cross section. These siding boards are usually attached to the outside of a home or other building by use of nails or screws. Clapboard siding may be painted, or the natural surface of the wood may be exposed. Popular types of wood for making natural surface clapboard siding for outdoor use include redwood and cedar. Each of these types of wood generally have an attractive appearance, and are more durable upon exposure to the elements than many other types of wood.

Conventionally, clapboard siding is manufactured by what is known as a “single-board method.” A single solid board of wood whether of one natural piece or finger-jointed from a series of blocks into a board of a species such as cedar or redwood, is selected which is about 1¼ to 2 inches thick and between 6 and 8 inches wide. Varying lengths of board are common or if finger-jointed, a length can be specified. The board is sawed lengthwise along a diagonal plane dividing the board into two boards with roughly triangular-shaped cross sections. There is some market preference for siding and planking boards that have a rough sawn textured face. The resawn single board method of conventional fabrication imparts that texture through the slanted resawing used to produce a bevel siding. A notch is cut along the lengths of each of the boards. Next, the boards are inspected and any defects such as loose knots or splits or rough unattractive wood grain are cut out. Occasionally defects are repaired by a method such as patching and touch sanding. When installed on a building, the manufactured boards are secured to the side of a building in an interlocking or overlapping pattern with screws or nails, and butted end to end.

One disadvantage of this conventional method of manufacturing siding is that it is time consuming and labor intensive. Because solid wood planks are used, boards are usually fed through the machinery to carry out the process one board at a time, producing two siding pieces per solid wood board. This results in a relatively low output of siding boards for the amount of time that a worker must operate the machine. Consequently, this results in high labor costs and an increased cost for purchasers of the siding boards.

Another disadvantage of this method is that it is costly in terms of materials. The use of large cross sectional pieces of expensive softwoods to manufacture siding boards increases the cost.

Still another disadvantage is that if the consumer wants a natural or stained finish differences in the surface appearance or quality of the siding boards often occur. Because large quantities of siding board are required to cover an average home or building, boards produced from many trees are often used. This results in variations in the grain and surface appearance of the boards. Purchasers sometimes demand uniformity in surface appearance, and producers are forced to spend significant amounts of time and energy selecting wood to produce the large volume of similarly colored and textured boards. These factors combine to raise the prices for purchasers still further and complicate the task of manufacturers and dealers.

Another disadvantage associated with the use of solid cedar or redwood for the siding boards is the difficulty in drying boards made from these woods. Although cedar and redwood both have good resistance to weathering when exposed to the elements, both are slow and difficult to dry and cure. Often, thick planes or boards are resawn or processed into siding boards when they are not fully dry. Because the outside of a board dries before the inside, in a partially dry board moisture is concentrated in the center of a board. When a siding board is sawn as described above, the wood has a greater moisture content in the newly exposed front face of the siding board than in the back of the siding board. This can result in splitting, cracking, cupping, warping, or bowing of the newly manufactured siding board as it ages. If knotty boards are used, it is common that knots fall out as the board ages. Consequently, producing siding by this process sometimes results in wasting quantities of expensive materials due to degrade as seasoning of the board occurs or degrade from manufacturing occurs. Additionally, the process of finger-jointing while using shorter blocks is time consuming, waste producing, costly, and develops a product generally suitable only for painting, not staining.

Another type of popular wood siding is known as “ship-lap” siding. Ship-lap siding generally includes vertically placed elongated boards which are generally almost square in cross section. Each board normally includes a tongue on one side, and a groove on the other that interlocks. Also, the boards are beveled on each side so that when installed, they produce the “ship-lap” effect. These boards are normally attached to the inside walls of a home or other building by nails or screws. Ship-lap siding may be painted, or the natural surface of the wood may be exposed. Popular types of wood for making natural surface ship-lap siding include redwood, cedar, pine, fir, spruce, aspen and alder.

Ship-lap siding boards are manufactured in a process similar to clapboard siding boards. A single solid wood board is planed, and optimally, tongue and groove configurations are cut on the edges. Then, the board is sawed lengthwise along a plane in the center of the board. When installed, the siding boards are attached to a wall in an interlocking pattern and secured by nails or screws.

Ship-lap siding boards are generally produced by a single board process, just as clapboard siding is, and consequently this method of manufacture of ship-lap siding also requires expensive materials and faces difficult curing problems as described above. Flooring and ceiling boards and interior plank paneling are fabricated in a similar fashion. The addition of a profile and the removal of the beveled edge is generally all that is needed to manufacture flooring and ceiling boards from the same manufacturing process as ship lap siding.

In view of the above, it should be appreciated that there is a need for wood siding boards, plank paneling, and flooring, and ceiling boards and a method for manufacturing the same that reduces labor costs by increasing productivity; that reduces the amount of expensive materials used; that reduces the wastage of expensive materials due to problems with drying and curing difficult woods; and that provides uniformly attractive and similarly colored and grained siding boards. The present invention satisfies these and other needs and provides further related advantages.

### SUMMARY OF THE INVENTION

The present invention provides an improved wood siding planking, paneling ceiling and flooring boards and method for manufacturing the same that reduces labor costs by increasing productivity; that reduces the amount of expensive materials used; that reduces the wastage of expensive materials due to problems with drying and curing; and that produces more uniformly attractive and similarly colored and grained boards, and reduce the volume of environmentally sensitive woods, such as cedar and redwood, that are normally required to cover the same surface area as product of the present

The clapboard siding board of the present invention comprises a base layer formed from an engineered wood product, two resin layers, two veneer layers, and at least one filler strip. The resin layers are bonded to the front and back faces of the base layer and the veneer layers are bonded to the resin layers such that the veneer layers, the resin layers and the base layer form a solid board. The resin layer may also include woven or randomly oriented fibers to increase the bond strength. The board has a top edge and a bottom edge. The filler strip is attached near the bottom edge of the board so that the filler strip is configured to include a top edge receiving area, and may also attach the top edge to include the base layer, such that the top edge of a similar composite board may be inserted into the top edge receiving area.

According to another aspect of the invention, the method of making clapboard composite siding boards includes affixing a plurality of strips of cosmetic quality wood whether solid, natural, or finger-jointed veneer to a front side of a substrate of engineered wood product and a series of lesser quality strips of similar material on the back of the substrate to form a composite panel. Next, a plurality of substantially parallel channels is plowed in the back of the wood substrate portion of the composite panel such that a plurality of sections of panel are defined. Then, a filler strip is affixed in each of the channels. Next, a configuring channel is plowed in each of the filler strips and each of the plurality of sections. Finally, finished boards are separated from the plurality of sections along a line adjacent to each of the plurality of filler strips.

This method may include the use of veneer strips adhered to a substrate of engineered wood product. This provides the ability to manufacture a composite siding board of standard size and an attractive wood appearance while using thin strips of wood veneer rather than a board of solid wood. The number of siding boards which can be manufactured by a single shipment of redwood or cedar lumber is increased. Consequently, the price of each siding board, over the cost of a solid wood board, is reduced and the method is more environmentally-friendly, as it reduces the number of high-quality redwood and cedar trees cut down or any comparable volume of product made by other means.

Another advantage is that veneer strips are generally easier to dry and cure than thicker boards. This reduces the likelihood that expensive boards will be ruined by curing induced defects such as cupping, warping, and bowing.

A further advantage is that the present method allows for the manufacture of multiple siding boards at a time on a single production line. This may increase productivity over the single board method described above and consequently can reduce labor costs per siding board manufactured.

An additional advantage is that the use of veneer strips can increase the likelihood that a large number of boards can be manufactured with a uniform grain and appearance, because a single redwood or cedar tree, with its own unique color variations, can be used to produce far more composite siding boards than solid wood boards.

Yet another advantage is that the potential for knots to fall out and splits to open and widen over time is virtually eliminated, because the strong bond between the veneer and the substrate prevents significant additional degrade of the veneer.

A still further advantage exists due to the preferred types of resin used. The preferred resins all cure at lower temperatures than hot press resins and thus eliminate the need for any hot pressing. Consequently, the possibility of burning, over drying or thermal degradation of the expensive veneer wood is avoided. Furthermore, by eliminating hot pressing the chance for delamination of the veneer to the substrate and the delamination of the substrate itself is virtually removed.

Other features and advantages of the present invention will become apparent from the following description of the preferred embodiments, taken in conjunction with the accompanying drawings, which illustrate, by way of example, the principles of the invention.

### BRIEF DESCRIPTION OF THE DRAWINGS

FIG. 1 shows a clapboard siding composite board of the present invention.

FIG. 1A shows the clapboard siding composite board of FIG. 1 with an alternate embodiment filler strip.

FIG. 2 shows an exploded view of a composite panel manufactured in accordance with the present invention.

FIG. 3 shows a perspective view of the panel of FIG. 2 with a plurality of channels in accordance with the present invention.

FIG. 3A illustrates an alternative embodiment stepped channel of the composite panel of FIG. 3.

FIG. 4 shows the panel of FIG. 2 with filler strips affixed in the channels.

FIG. 4A illustrates an alternative embodiment filler strip affixed in the channels of FIG. 3A.

FIG. 4B illustrates another alternative embodiment filler strip affixed in the channels of FIG. 3.

FIG. 4C illustrates another alternative embodiment filler strip affixed in the channels of FIG. 3A.

FIG. 4D illustrates another alternative embodiment filler strip showing notches for drip line control cut in the filler strip which is affixed in the channels of FIG. 3.

FIG. 5 shows the panel of FIG. 3 with excess material removed from the filler strips and the base layer.

FIG. 6 shows a cross sectional view of the composite siding boards of the present invention installed on the side of a wooden wall.

FIG. 7 shows a ship-lap siding composite panel board of the present invention.

FIG. 8 shows the composite panel of FIG. 3 with filler strips for ship-lap siding boards affixed in the channels.

FIG. 8A shows an alternative shape of channel and filler strip for ship-lap siding boards.

FIG. 9 shows an enlarged cross sectional view of a channel and filler strip of FIG. 8 with a configuring channel plowed in the veneer side of the panel.

FIG. 10 shows the panel of FIG. 9 and as a cross-hatched area, the separating channel, located where it will be plowed in the back side of the panel.

FIG. 11 is a perspective view of ship-lap composite boards demonstrating how they will overlap when installed on a wall.

FIG. 12 is an alternative embodiment of the ship-lap composite boards of FIG. 11.

### DESCRIPTION OF THE PREFERRED EMBODIMENTS

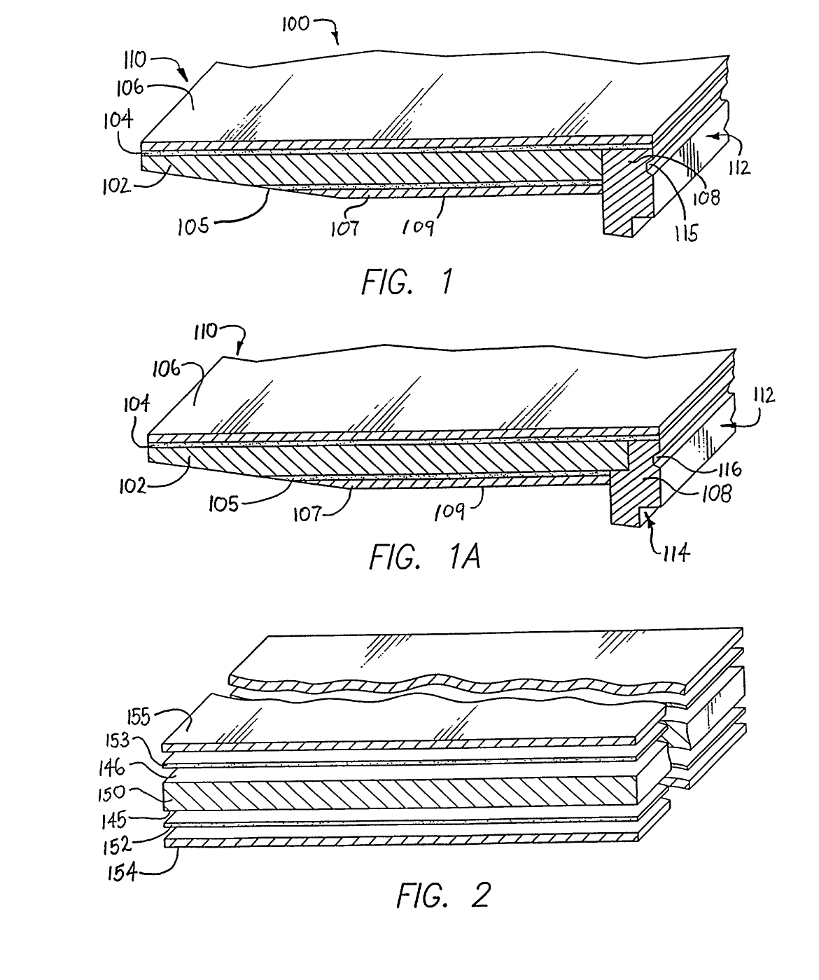

A clapboard siding composite board 100, shown in FIG. 1, includes a base layer 102, a first resin layer 104, a second resin layer 105, a face veneer layer 106, a backing veneer layer 107, a filler strip 108 and seal coat 109. This composite board has a top edge 110 and a bottom edge 112. The base layer 102 is formed from an engineered wood product that is different from the veneer. Preferred engineered wood products include plywood, laminated veneer lumber, oriented strand board, end and edge glued panels commonly known as blackboard, and for interior use, medium density fiberboard and particle board. Preferably, the base layer is at least 5/16 inches thick. Bonded to the base layer 102 are the resin layers 104, 105. The resin layers may be selected from one of several different kinds of glues and plural component polymer resins, including but not limited to polyurethane, polyester, polyurea and MDI isocyanate resins and hybrid mixtures of these compounds. The resin layers may include woven or randomly oriented natural, glass, or plastic polypropylene or polyester fibers to increase bond strength and tensile strength. Bonded to the first resin layer 104 is the face veneer layer 106. The face veneer layer 106 is formed from a cosmetic quality solid wood veneer. Examples of types of wood which may be used include redwood, cedar, pine, fir, and spruce. Preferably, but not necessarily, the veneer is between one sixteenth inches and three-eighths inches thick when fabricated. Bonded to the second resin layer 105 is the backing veneer layer 107. Depending on the type of base layer used, the backing veneer layer brings added stability and strength to the panel. The backing veneer layer 107 is formed from a durable but not cosmetic quality solid wood veneer, composite wood product, plastic layer, or plastic resin impregnated laminate. These layers of base, resin and face and back veneer, when fully fabricated, form a solid board which may vary in width, but is generally between about 6″ and 12″ wide nominally. When installed, as discussed below, the board creates the illusion of being made entirely of solid wood having the same appearance and quality of the face veneer layer 106. Thus, a smaller amount of cosmetically attractive wood ends up on the surface as a face veneer which is used to make each board than would be needed for boards made from the single board method. Additionally, use of veneer eliminates certain problems associated with thicker solid boards of redwood and cedar as described above.

The filler strip 108 is affixed to the bottom edge 112 of the composite board. Preferably, this is accomplished by use of the same resin used for the resin layers 104, 105. The cross section of the filler strip 108 is the shape of a larger square with a smaller square removed from the lower left corner of the larger square to create a notch. This notch provides a top edge receiving area 114. The filler strip may also include a drip-line control notch 115.

With reference to FIG. 1A, an alternate embodiment of the filler strip 108 has a cross section which is roughly “Z” shaped. This embodiment also includes a top edge receiving area 114. Like the previous embodiment of the filler strip 108, it may include a drip control line notch 116. The addition of a sealant layer 109 to the back adds further durability and dimensional stability to the fabricated board.

The clapboard siding composite panel board may be of varying lengths, but it is preferably manufactured in eight foot lengths as described below. The lengths may be joined at the end to produce longer boards as desired by jointing individual boards or the entire lengths of composite panels during manufacture.

The method of manufacture of the clapboard composite siding panel begins by selecting a base layer 150 of engineered wood product. Preferred types of engineered wood product are plywood, laminated veneer lumber, blockboard, oriented strand board, medium density fiberboard, and particle board. (See FIG. 2). First resin layer 152 and second resin layer 153 are applied to the bottom face 145 and top face 146 of base layer 150, respectively. The resin may be any suitable exterior catalyzed polyvinyl acetate polymer, but is preferably a hybrid or plural component formulation of polyurethane and polyester, or polyurea. Most preferably, the resin is a sprayable syntactic catalyzed resin of the above polymers. The resin should provide weather durability, good moisture protection, create a strong bond, add tensile strength, have superior filling qualities for filling voids or gaps in the substrate or veneer, and be adequately flexible when cured. Flexibility is required because the finished siding boards will tend to be flexed during processing, transportation and installation. At this time, woven or randomly oriented fibers may be added to the resin layers.

The preferred resins all cure at low temperatures and without the need for external heating. This eliminates the need to heat the siding panel in a conventional hot press, as would be required if normal phenolic based resins were used. The preferred resins are also more tolerant of variations in the moisture content of the veneers and engineered wood substrate. Because the need for hot pressing is eliminated, the possibility of delaminating, burning, overdrying, or thermally degrading the wood veneer and the engineered wood substrate is also eliminated. This results in greater production efficiency, quality control, durability and longer life of the composite siding board manufactured with this method.

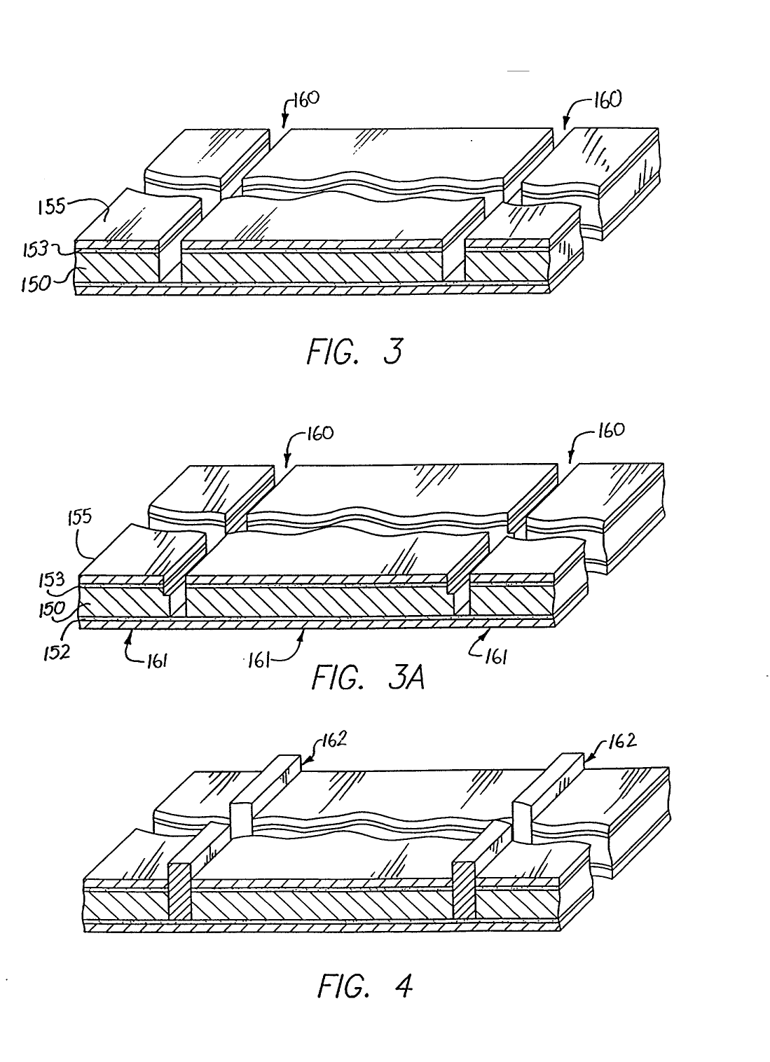

Next, a face veneer layer 154 is bonded to the first resin layer 152 and a backing veneer layer 155 is bonded to the second resin layer 153. These veneer layers are generally composed panels of thin strips of veneer and are positioned such that the entire surface of both resin layers 152, 153 are covered. The resin layers 152, 153 quickly cure and form a strong bond between the base layer 150 and the veneer layers 154, 155. If a rough sawn texture is desired in the finished plank or siding it can be added by running the composite panel on a rougher head planer, rougher belt sander running across the width of the panel or a cross width rougher chain panel machine which can give the similar appearance as resawn boards to the panel face. Next, a plurality of parallel channels 160 are plowed in the composite panel. Preferably, prior to plowing the channels, the composite panel is oriented so that the channels can be plowed from above the panel. However, the channels may also be cut by a plurality of bottom cutting saws. These channels cut through the backing veneer layer 155, second resin layer 153 and base layer 150 of the composite panel by a plurality of evenly spaced saws or cutter head tooling. (See FIG. 3).

The channels 160 may have perpendicular sides in cross section, trapezoidal, or may be step-shaped. (See FIGS. 3 and 3A). The depth of the channels 160 may vary depending on manufacturer and customer preferences, but may extend through the entire base layer 150 and into or through the first resin layer 152. Preferably, the channels 160 extend along the entire length of the composite panel. This visually divides the panel into a plurality of sections 161 but does not yet split the panel into such sections.

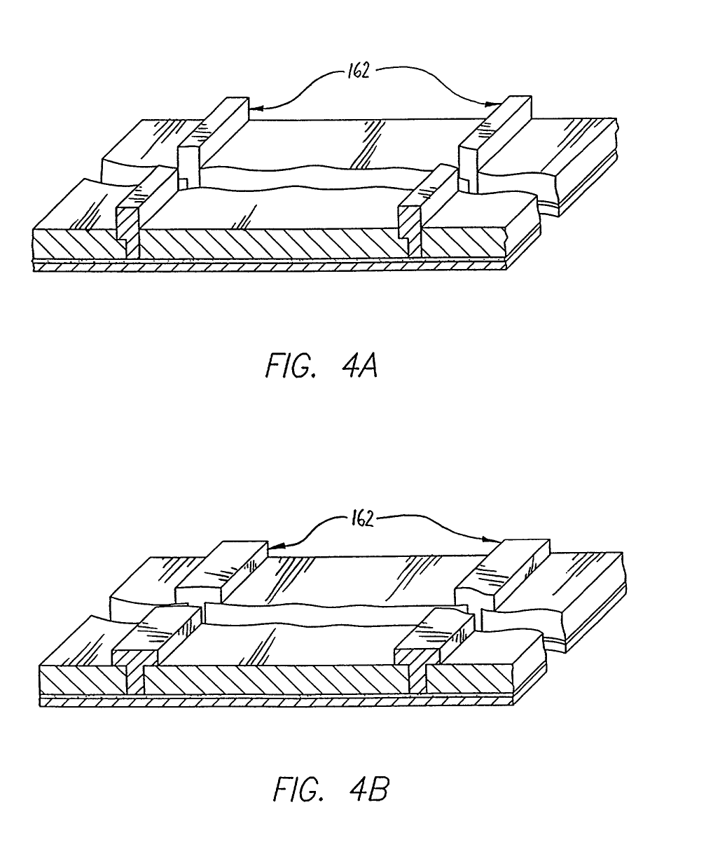

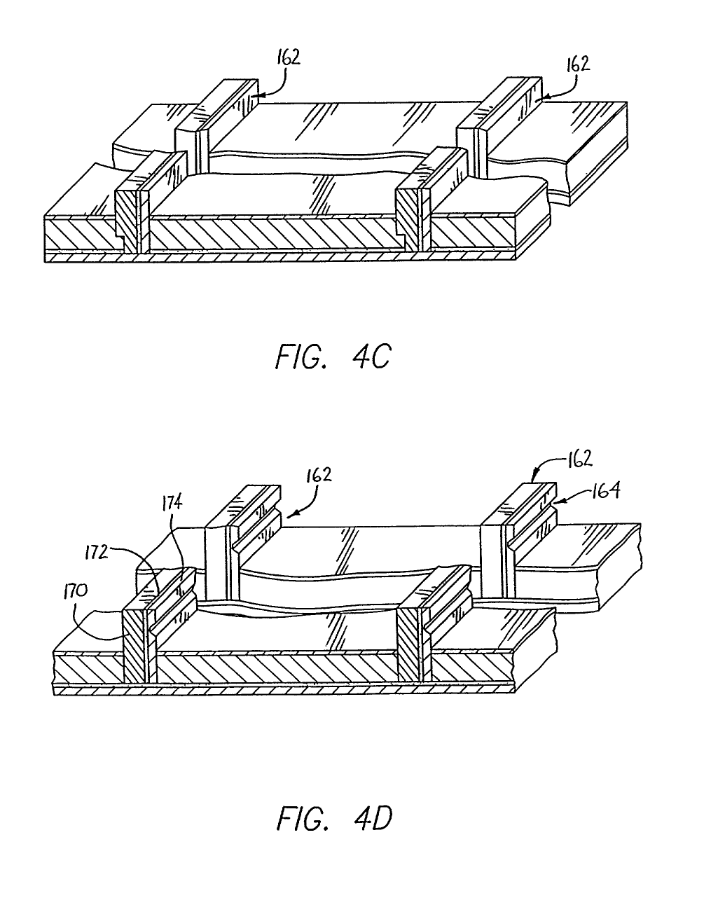

After the channels 160 are plowed, a plurality of filler strips 162 are affixed in the channels 160, as shown in FIGS. 4, 4A, 4B, 4C and 4D. (For clarity and simplicity, the optional second resin layer 153 and backing veneer layer 155 are not shown in FIGS. 4A-D). The filler strips 162 are affixed by use of a resin, preferably the same type of resin chosen for the resin layers 152, 153. The filler strips are cut to fit snugly into the channels and may be square, trapezoidal, T-shaped, step-shaped, or U-shaped in cross section as needed to meet manufacturing requirements. It will be readily understood that the shape and thickness of the filler strip can be varied to alter the angle of the bevel and the simulated thickness of the plank when a siding board manufactured by this method is installed on a building. The filler strips 162 may also include an optional drip control line notch 164. (See FIG. 4D). Additionally, the filler strips 162 may be formed from sections of another composite panel, and include a filler strip base layer 170, a filler strip resin layer 172 and a filler strip veneer layer 174. (See FIGS. 4C, 4D). Each filler strip may also be formed from a polymer, a polyurethane, a polyester, a styrene or a hybrid combinations of these components. This type of filter strip may be applied to the channels either in solid form, or it may be pumpted or sprayed on in quick curing liquid or paste form.

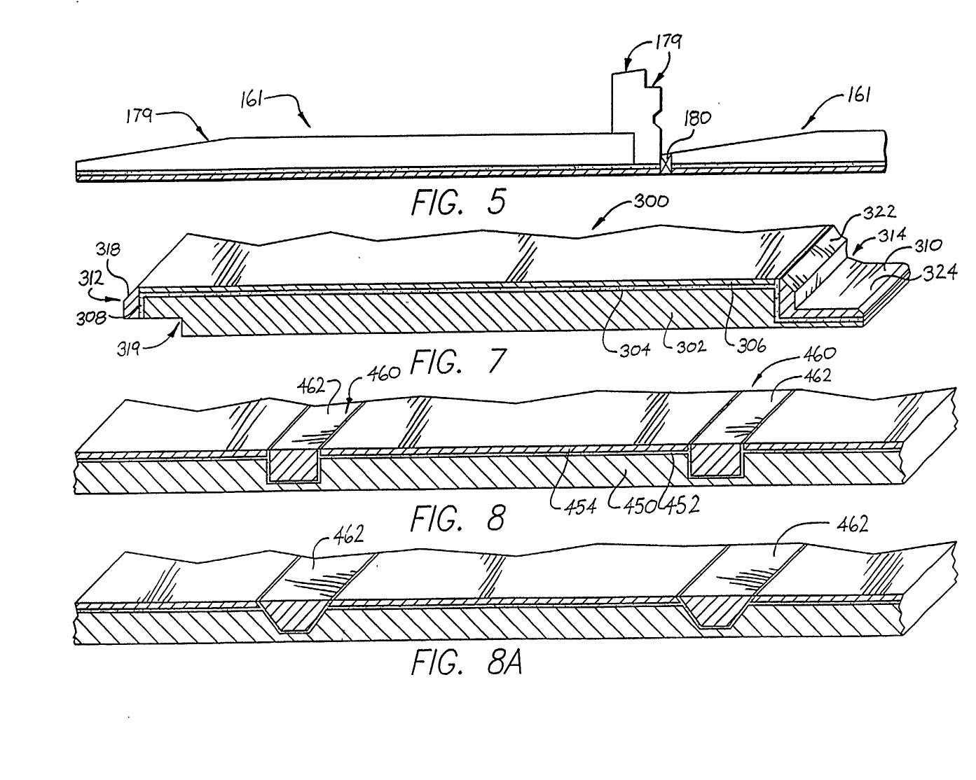

After the plurality of filler strips are firmly affixed, depending on the ultimate configuration of siding board desired, excess portions 179 of the panel and filler strip may be removed to give the composite siding boards their final shape, and the composite panel is separated into a plurality of composite panel siding boards simultaneously. (See FIG. 5). The cross hatched portions or cut lines 180 are removed by use of a plow and cutter head tooling from each of the plurality of sections 161 of the composite panel thus separating the composite panel into a plurality of individual sections 161. It is understood that the location of the cut lines 180 may be varied, if desired so that the filler strip 162 is divided between two adjacent sections 161. Thus, a large number of siding boards can be manufactured at the same time by a single assembly line, in contrast to the single board method described above. This provides for more efficient use of machinery and labor.

The clapboard siding composite board may be of varying lengths. However, it is preferably manufactured in eight foot lengths as described above, because veneer is more easily handled in 8′ lengths and engineered wood substrate is usually manufactured in 8′ lengths. Thereafter, boards or panels may be joined at the ends with a finger-joint or a scarfjoint to create longer boards or planks. Preferably, the composite panels are joined at ends by resins similar to the resin layers to produce longer length composite panels with lengths up to 24 feet not being unusually difficult to make. However the preferred length is 16′. If desired, specified length boards or planks may be fabricated by the same process, and crosscut to desired length in panels before separating into boards or planks.

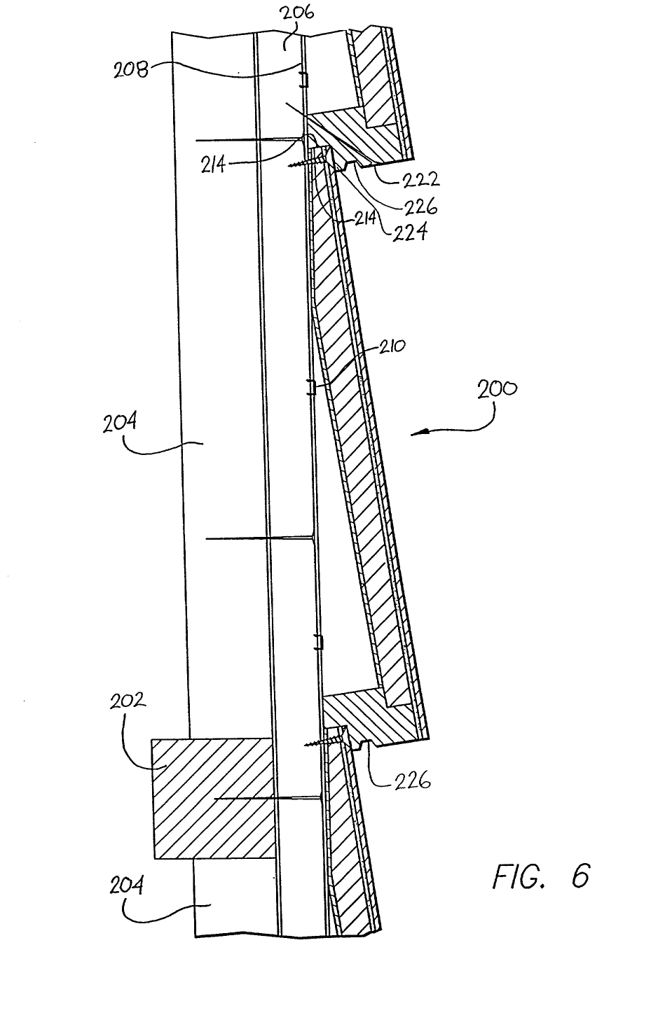

The composite siding boards 200 manufactured by the above method are installed on the side of a structure as shown. (See FIG. 6). The structure will customarily be wooden frame construction and will include a plate 202, studs 204 and a sheeting board 206. The structure may also include water resistant sheeting paper or house wrap 208 attached to the sheeting board 206 by fasteners 210.

Each composite siding board 200 is positioned such that the top edge 212 is in contact with the house wrap 208 and the top-edge receiving area 214 of the board 218 installed immediately above it. The composite siding board 200 is then securely attached to the structure by nails 222 or screws 224, which are customarily positioned as shown but may be positioned at the option of the installer. Once installed, the optional drip control line notch 226 serves to prevent downwardly flowing water from seeping into the top edge receiving area 214 of the siding board 200 and into contact with the house wrap 208 by creating an area where water will collect and be drawn away from the top edge receiving area 214 by the force of gravity. The location of the drip control line notch is optional but placement closer to the face is preferred.

A ship-lap composite siding board 300 includes a base layer 302, a resin layer 304, a veneer layer 306, a shaped bevel receiving strip 308, and a similarly shaped bevel insertion strip 310. (See FIG. 7). The composite board 300 also includes a receiving side 312 and an insertion side 314. The base layer 302 is formed from an engineered wood product, such as plywood, laminated veneer lumber, blackboard, oriented strand board or medium density fiberboard or particle board. Preferably, the base layer is 7/16 inches thick. Bonded to the base layer 302 is the resin layer 304. The resin layer may be selected from one of several different kinds of polymer resins or hybrids of plural component polymers, including but not limited to polyurethane, polyester, polyurea and isocyanate resins. Preferred resins have demonstrated durability to prolonged exposure to the elements, moisture resistance and flexibility. Bonded to the resin layer 304 is the veneer layer 306, which is formed from a cosmetic quality solid wood veneer. Examples of types of wood which may be used include redwood, cedar, pine, spruce, and fir. If the produce is to be used for plank flooring a Douglas fir, yellow pine or hardwood veneer is preferred. Preferably, the veneer is between 1/16 and ⅜ inches thick. These three layers form a solid board which may vary in width, but is generally between about 7/16 to ¾ inches thick. Each board is generally between 6 and 12 inches wide, nominally. Optionally, a layer of resin 305 and a utility backing veneer 307 may be added for stability and durability. For clarity and simplicity these layers are not shown in subsequent drawings.

The receiving strip 308 is composed of the same type of wood as the veneer layer 306 and is attached to the receiving side 312 of the board 300. Preferably, this is accomplished by use of the same resin used for the resin layer 304. The receiving strip 308 includes a receiving side machined with a radius or a bevel 318 and gives the illusion that the board 300 is composed solid wood of the same wood as the veneer layer 304 for the entire depth of the receiving side bevel 318. The receiving side also includes an insertion strip receiving area 319.

At the insertion side 314 of the board 300, the insertion strip 310 is attached to the board 300. Again, it is preferred that this be accomplished by use of the same resin used for the resin layer 304. The insertion strip 310 includes similarly shaped edge with a radius or a beveled face 322 and an insertion portion 324. The insertion side bevel 322 further gives the illusion that the board 300 is composed of the same type of wood as the veneer layer 304 for the entire depth of the insertion side bevel 322. The insertion portion 324 extends laterally from the board 300.

The method of manufacture of the ship-lap composite siding begins by selecting a base layer 450 of engineered wood product, such as plywood, blackboard, laminated veneer lumber, oriented strand board, medium density fiberboard or particle board. (See FIG. 8). A resin layer 452 is applied to the base layer 450. The resin layer 452 may be any suitable polymer or hybrid of plural component polymers, but is preferably polyurethane, polyester or polyurea, cured with an isocyanate resin. Examples of types of resins and glues include MDI isocyanate, exterior catalyzed PVAs, polyesters, hybrids of polyurethane and polyesters. As previously explained, these types of resin can provide durability, tensile strength, good moisture protection, create a strong bond, have superior filling qualities for filling voids or gaps in the substrate or veneer, and are adequately flexible when cured. Flexibility is required because the finished siding boards or planks will tend be flex during processing, transportation and installation.

Next, a veneer layer 454 is bonded to the resin layer 452. (Similarly the optional backing veneer is bonded to the base layer 450.) Thin strips of veneer are positioned such that the entire resin layer 452 is covered. The resin layer 452 quickly cures and forms a strong bond between the base layer 450 and the veneer layer 454. Then, a plurality of channels 460 are plowed in the substrate portion of the composite panel by a plurality of evenly spaced saws or cutter head tooling. Preferably, prior to plowing the channels, the composite panel is oriented so that the channels can be plowed from above the panel. However, the channels may also be cut by a plurality of bottom cutting saws.

The channels 460 may be square or trapezoidal in cross section. (See FIG. 8 and 8A). Next, a plurality of filler strips 462 are bonded into the channels 460, preferably with the same resin as the resin layer 452.

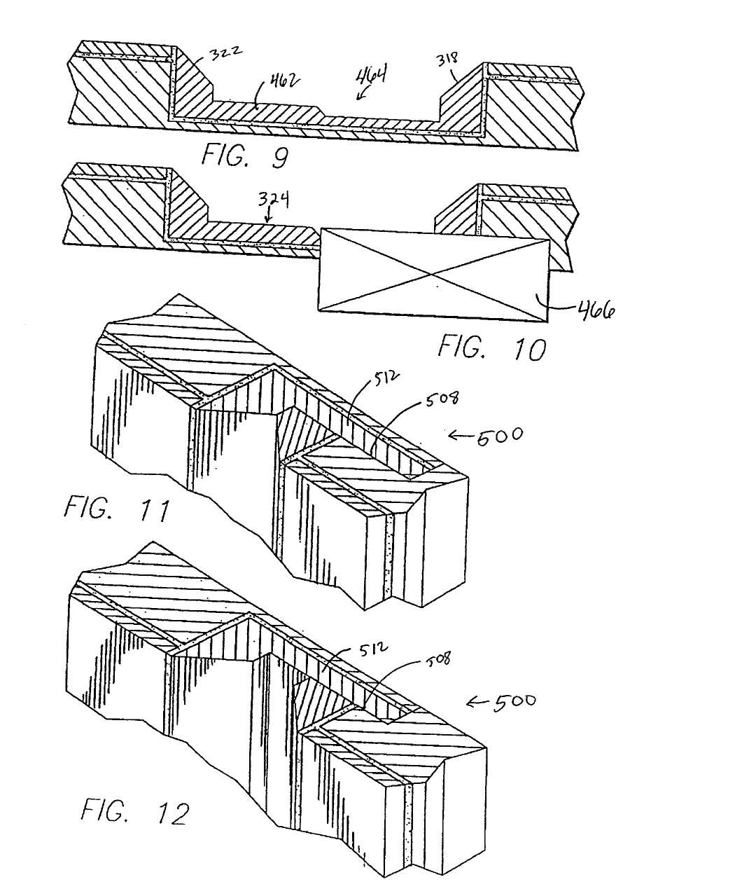

After the plurality of filler strips 462 are firmly affixed, a configuring channel 464 is plowed along the length of each of the filler strips 462. (See FIG. 9). The configuring channel 464 defines the receiving side bevel 318 and the insertion side bevel 322. The panel remains intact at this point. After the plurality of configuring channels have been plowed, a separating channel 466 is plowed along the length of each of the filler strips 462, from the backside of the panel which separates the panel into a multitude of boards or planks. The separating channel 466, shown as a cross-hatched cross section in FIG. 10, defines the insertion strip receiving area 319 and the insertion portion 324. At the option of the fabricator the dimensions of the width and depth of the configuring channel 464 and the separating channel 466 may be varied so that the insertion strip receiving area 319 can be varied in size. This allows completed boards to be installed on a wall with variations in the appearance of the joint between the installed boards. (See FIG. 11 and 12). Plowing of the separating channel 466 separates the composite panel into individual ship-lap composite boards. If the bevel is substituted for a radius the boards may have a planking appearance with a shiplap joint on the edges.

The ship-lap composite siding boards 500 manufactured by the above method are shown installed vertically on a wall. (See FIGS. 11 and 12). Each ship lap composite siding board 500 is positioned such that the insertion portion 512 is in contact with the insertion strip receiving area 508, thus overlapping or interlocking adjacent boards together. The boards are secured to the wall by fasteners.

The same product may be installed on a ceiling or on a floor or horizontally on a wall or in any particularly desired manner for cosmetic or utilitarian effect.

From the foregoing, it will be appreciated that the method of manufacture of composite siding boards of the present invention can reduce labor costs by increasing productivity; can reduce the amount of expensive materials used; can reduce the wastage of expensive materials due to problems with drying and curing difficult woods; and provides uniformly attractive and similarly colored and grained siding boards.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A composite siding board comprising:
a base layer formed from an engineered wood product;
a resin layer;
a veneer layer;
a filler strip;
wherein the resin layer is firmly bonded to the base layer and the resin layer is firmly bonded to the veneer layer such that the veneer layer, the resin layer and the base layer form a solid board, the board has a top edge and a bottom edge, the filler strip is attached near the bottom edge of the board, and the filler strip is configured to include a top edge receiving area such that the top edge of a similar composite board can be inserted into the top edge receiving area.

2. A composite siding board comprising:
a base layer formed from an engineered wood product and having a front side and a back side;
a first resin layer;
a second resin layer;
a face veneer layer;
a backing veneer layer; and
a filler strip;
such that the first resin layer is firmly bonded to the front side and the second resin layer is firmly bonded to the back side, with the face veneer layer firmly bonded to the first resin layer and with the backing veneer firmly bonded to the second resin layer, and such that the veneer layer, the resin layer and the base layer form a solid board, the board having a top edge and a bottom edge, with the filler strip attached near the bottom edge of the board, and the filler strip configured to include a top edge receiving area such that the top edge of a similar composite board can be inserted into or covered over by the top edge receiving area.

3. The composite siding board of claim 1 wherein the base layer is composed of an engineered wood product selected from the group consisting of plywood, blackboard, laminated veneer lumber, oriented strand board, exterior hardboard, particle board, medium density fiberboard or hardboard.

4. The composite siding board of claim 1 wherein the veneer layer is selected from the group consisting of cedar, redwood, fir, pine, spruce, alder and aspen.

5. The composite siding board of claim 1 wherein the veneer layer is less than three-eighths of an inch thick.

6. The composite siding board of claim 1 wherein the resin layer is composed of a resin selected from the group consisting of polyurethanes, polyesters, polyureas, MDI isocyanates, plural component hybrid formulations, catalyzed polyvinyl acetates and durable exterior resins.

7. The composite siding board of claim 1 wherein the resin layer further comprises a fibrous mesh layer.

8. The composite siding board of claim 7 wherein the fibrous mesh layer is woven.

9. The composite siding board of claim 7 wherein the fibrous mesh layer comprises fibers randomly dispersed throughout the resin layer.

10. The composite siding board of claim 7 wherein the fibrous mesh layer is composed of fibers selected from the group consisting of plastic, glass and natural fibers.

11. The composite siding board of claim 1 wherein the filler strip is attached to the board with a resin.

12. The composite siding board of claim 11 wherein the resin is selected from the group consisting of polyurethanes, polyesters, polyureas, MDI isocyanates, plural component hybrid formulations, catalyzed polyvinyl acetates and durable exterior resins.

13. The composite siding board of claim 1 wherein the filler strip is attached to and in contact with the base layer, the resin layer and the veneer layer.

14. The composite siding board of claim 1 wherein the filler strip is attached to and in contact with the base layer and the resin layer.

15. The composite siding board of claim 1 wherein the filler strip includes a drip-line notch.

16. The composite siding board of claim 1 wherein said board is at least eight feet in length.

17. The composite siding board of claim 16 wherein said board comprises at least two smaller composite siding boards joined together by a resin bond.

18. A composite siding board comprising:
a base layer formed from an engineered wood product;
a resin layer;
a veneer layer;
a receiving strip;
an insertion strip;
wherein the resin layer is firmly bonded to the base layer and the resin layer is firmly bonded to the veneer layer such that the veneer layer, the resin layer and the base layer form a solid board, the board has a receiving side and an insertion side, the receiving strip is firmly attached to the receiving side of the board, the insertion strip is firmly attached to the insertion side of the board, the receiving side of the board is configured to include an insertion strip receiving area and the insertion strip receiving area is configured such that a portion of the insertion side of a similar composite siding board can be inserted into the insertion strip receiving area.

19. The composite siding board of claim 18 wherein the base layer is composed of an engineered wood product selected from the group consisting of plywood, blockboard laminated veneer lumber, oriented strand board, exterior hardboard, Medium density fiberboard, Medium density fiberboard hardboard and particle board.

20. The composite siding board of claim 18 wherein the veneer layer is selected from the group consisting of cedar, redwood, pine, fir, spruce, alder and aspen.

21. The composite siding panel board of claim 18 wherein the resin layer further comprises a fibrous mesh layer.

22. The composite siding panel board of claim 21 wherein the fibrous mesh layer is woven.

23. The composite siding board of claim 21 wherein the fibrous mesh layer comprises fibers randomly dispersed throughout the resin layer.

24. The composite siding board of claim 18 wherein the receiving strip and the insertion strip are each attached to the panel with a resin.

25. The composite siding board of claim 18 wherein the receiving strip and the insertion strip are manufactured from the same material as the veneer layer.

26. A method of making composite siding board comprising:
affixing a plurality of strips of cosmetic quality wood veneer to a front side of a substrate of engineered wood product to form a composite panel;
plowing a plurality of substantially parallel channels in the wood substrate portion of the composite panel such that a plurality of sections of panel are defined;
affixing a filler strip in each of the plurality of channels;
plowing a configuring channel in each of the filler strips and each of the plurality of sections; and
separating each of the sections from the plurality of sections along a line adjacent to each of the plurality of filler strips.

27. The method of claim 26 wherein the strips of cosmetic quality wood veneer are selected from the group consisting of cedar, redwood, pine, fir, spruce, aspen, alder, and other hardwoods.

28. The method of claim 26 wherein the engineered wood product is selected from the group consisting of plywood, blockboard oriented strand board, laminated veneer lumber, exterior hardboard, medium density fiberboard, hardboard and particle board.

29. The method of claim 26 wherein the plurality of strips of veneer are affixed to the panel by a applying a resin layer to the substrate and bonding the plurality of strips of veneer to the resin layer.

30. The method of claim 29 wherein the resin layer is selected from the group consisting of plural component polymers, hybrids or formulations of MDI's, isocyanates, catalyzed polyvinyl acetates, polyurethanes, polyesters and polyureas.

31. The method of claim 29 wherein the resin layer is a sprayable syntactic catalyzed compound.

32. The method of claim 29 further comprising applying a fibrous mesh layer to the resin prior to bonding the plurality of strips of veneer.

33. The method of claim 32 wherein the fibrous mesh layer is woven.

34. The method of claim 32 wherein the fibrous mesh layer is randomly distributed across the resin layer.

35. The method of claim 32 wherein the fibrous mesh layer is randomly distributed throughout the resin layer.

36. The method of claim 26 wherein the plowing of the plurality of substantially parallel channels is accomplished by a plurality of evenly spaced saws and cutter head tooling.

37. The method of claim 26 wherein the plurality of channels have a cross section which is substantially square.

38. The method of claim 26 wherein the plurality of channels have a cross section which is substantially trapezoidal.

39. The method of claim 26 wherein the plurality of channels have a cross section which is substantially rectangular.

40. The method of claim 26 wherein the plurality of channels have a cross section which is substantially U-shaped.

41. The method of claim 26 wherein the plurality of channels have a cross section which is substantially step-shaped.

42. The method of claim 26 wherein the filler strip is selected from the group comprising cedar, redwood, pine, fir, spruce, aspen and alder.

43. The method of claim 26 wherein the filler strip is selected from the group comprising a polymer, polyurethane, a polyester, a styrene or a hybrid combination of these components.

44. The method of claim 26 wherein the filler strip and the plurality of strips of veneer are made of the same material.

45. The method of claim 26 wherein the filler strip comprises:
a base layer of engineered wood product; and
a veneer layer;
wherein the veneer layer is affixed to the base layer.

46. The method of claim 45 wherein the filler strip is affixed to the base layer by a resin.

47. The method of claim 45 wherein the resin is selected from the group consisting of plural component polymers of polyurethanes, polyesters, polyureas, and styremes with catalysts and fillers.

48. The method of claim 45 wherein the resin is a sprayable syntactic catalyzed compound.

49. A method of making composite panel siding comprising:
affixing a plurality of strips of cosmetic quality wood veneer to a front side of a substrate of engineered wood product to form a composite panel having a cosmetic face veneer side and a back utility sealed side;
plowing a plurality of substantially parallel channels in the face veneer side of the composite panel such that a plurality of sections of panel are defined;
affixing a filler strip in each of the plurality of channels; and
removing excess material from each of the filler strips and each of the plurality of sections from the veneer side of the panel;
removing excess material from each of the filler strips and each of the plurality of sections from the back side of the panel, such that each of the sections is separated from the plurality of sections and an insertion strip and a receiving strip is defined on each of the sections.

50. The method of claim 49 wherein the strips of cosmetic quality wood veneer are selected from the group consisting of cedar, redwood, pine, fir, spruce, aspen, alder.

51. The method of claim 49 wherein the engineered wood product is selected from the group consisting of plywood, blockboard oriented strand board, laminated veneer lumber and medium density fiberboard and particle board.

52. The method of claim 49 wherein the plurality of strips of veneer are affixed to the panel by a applying a resin layer to the substrate and bonding the plurality of strips of veneer to the resin layer.

53. The method of claim 52 wherein the resin layer is selected from the group consisting of plural component polyurethanes, polyesters and polyureas.

54. The method of claim 52 wherein the resin layer is a sprayable syntactic catalyzed compound.

55. The method of claim 51 further comprising applying a fibrous mesh layer to the resin prior to bonding the plurality of strips of veneer.

56. The method of claim 55 wherein the fibrous mesh layer is woven.

57. The method of claim 55 wherein the fibrous mesh layer is randomly distributed across the resin layer.

58. The method of claim 55 wherein the fibrous mesh layer is randomly distributed throughout the resin layer.

59. The method of claim 49 wherein the plowing of the plurality of substantially parallel channels is accomplished by a plurality of evenly spaced saws and cutter head tooling.

60. The method of claim 26 wherein the plurality of channels have a cross section which is substantially square.

61. The method of claim 26 wherein the plurality of channels have a cross section which is rectangular.

62. The method of claim 26 wherein the plurality of channels have a cross section which is U-shaped.

63. The method of claim 49 wherein the plurality of channels have a cross section which is trapezoidal.

64. The method of claim 26 wherein the filler strip is selected from the group comprising cedar, redwood, pine, fir, spruce, aspen, and alder.

65. The method of claim 26 wherein the filler strip and the plurality of strips of veneer are made of the same material.

66. The method of claim 26 wherein the filler strip is a fast curing liquid polymer coating that is pumped onto the engineered wood product.

67. The method of claim 66 wherein the filler strip is a fast curing liquid polymer.
